(19) United States
(12) Patent Application Publication
(10) Pub. No.: US 2005/0247561 A1
(43) Pub. Date: Nov. 10, 2005

(54) Ceramic gas sensor

(76) Inventors: Kuo-Chuang Chiu, Hsinchu (TW); Ren-Der Jean, Hsinchu (TW)

Correspondence Address: HARNESS, DICKEY & PIERCE, P.L.C., P.O. BOX 8910, RESTON, VA, 20195, US

(21) Appl. No.: 10/928,208

(22) Filed: Aug. 30, 2004

(30) Foreign Application Priority Data
May 4, 2004 (TW) 93112496

(51) Int. Cl. G01N 27/26

(52) U.S. Cl. 204/424; 204/426

(57) ABSTRACT

A ceramic gad sensor comprises an upper electrode, a reaction layer, a lower electrode, and a ceramic cavity layer. The reaction layer is a ceramic substrate with one end provided with a reaction region that has a plurality of duct holes penetrating through the upper and lower surfaces of the substrate and a reaction film covering the upper surface of the reaction region. The reaction film is made of a detecting material and connected to the duct holes. There is also the detecting material provided inside the duct holes. The upper electrode is attached on the reaction film. The lower electrode is attached on the lower surface of the substrate and connected to the duct holes. The ceramic cavity layer is provided on the lower surface of the reaction layer with the lower electrode in between.

### BACKGROUND OF THE INVENTION

1. Field of Invention

The invention relates to a gas sensor and, in particular, to a ceramic gas sensor.

2. Related Art

Sensors are indispensable devices in automatic detecting systems and automatic control systems. Whether a sensor can correctly measure the detected quantity and convert it into the corresponding output quantity plays an important role in the precision of a system. According to different types of detected quantities, there are physical sensors that measure physical characteristic such as light, magnetism, temperature and pressure, and chemical sensors that measure chemical characteristic such as humidity and gas.

Normally, a gas sensor uses a special material whose electrical properties change after being adsorbed with certain gas. Since ceramic materials have superior detecting functions (e.g. high tolerance in heat, corrosion, and etching), they are widely used in the reaction layer of gas sensors. Some ceramic detecting materials are particularly sensitive to oxidization and reduction. They are ideal for detecting the component or temperature change of special gas. For example, ZrO₂—Y₂O₃ is an oxygen ion conductive ceramic whose feature is that its oxygen ions have high mobility at high temperatures. Thus, its conductivity changes with the oxygen concentration as a result of defects in the crystal. When ZrO₂—Y₂O₃ is used in an oxygen sensor, platinum electrodes are coated on both sides of the ceramic after sintering as the oxidization catalyst. When oxygen ions move, an electric motif is generated with the magnitude determined by the oxygen on the platinum electrodes.

As described in the U.S. Pat. No. 4,980,044, the structure and manufacturing method of a conventional flat ceramic sensor usually employ multilayer ceramic processes to form a flat gas sensor. A ZrO₂ ceramic substrate is used as the main structure material, followed by forming electrodes, dielectric ceramics, a reference gas cavity, and a solid-state electrolyte therein. As the solid-state electrolyte is a plate, it requires a lot of detecting materials. At the same time, the rigidity of the plate is worse. Therefore, the U.S. Pat. No. 6,572,747 proposes another manufacturing method for flat ceramic sensors. It also uses a dielectric as its main structure with a cavity formed therein to accommodate a reference gas. Its structure includes a stack of porous ceramic layer, an electrode layer, a solid-state electrolyte layer, and a carbon substrate with a cavity. The gas inside the cavity is the reference gas. It also includes a heating electrode as the heating device of the sensor. However, the solid-state electrolyte layer has a hole on one end of a dielectric ceramic plate that is filled with a solid-state dielectric material as its reaction region. The upper and lower surfaces of the reaction region are formed with electrodes to reduce the use of solid-state dielectric materials.

### SUMMARY OF THE INVENTION

In view of the foregoing, the invention provides a ceramic gas sensor that uses a specially designed reaction region to reduce the use of detecting materials. Using the ceramic stack structure, devices with different functions are integrated to form a multilayer ceramic gas sensor in order to achieve optimal functions and precisions.

The disclosed ceramic gas sensor comprises an upper electrode, a reaction later, a lower electrode, and a ceramic cavity layer. The reaction layer is a substrate with a reaction region formed on one end. The substrate has an upper surface and a lower surface. The reaction region contains a plurality of duct holes and a reaction film. The reaction film is made of a detecting material, covering the upper surface of the reaction region and connected to the duct holes. The duct holes penetrate through the upper and lower surfaces of the substrate. The duct holes are also filled with the detecting material for forming the reaction film. The upper electrode is attached on the reaction film. The lower electrode is attached on the lower surface of the substrate and connected to the duct holes. The ceramic cavity layer is provided on the lower surface of the reaction layer with the lower electrode in between. The ceramic cavity layer has a cavity in fluid communication with the environment and connected next to the lower electrode. The special design of the reaction layer can improve the functions of the ceramic gas sensor, while at the same time retain the structural strength and detecting properties of the reaction layer.

Using the disclosed multilayer ceramic structure, the multilayer ceramic gas sensor of the invention can be combined with a heating device, a temperature detecting device, or several gas detecting devices for wider applications. The properties and functions of the gas sensor can be tested before packaging in order to increase the production yield and control. The above-mentioned structure can combine with devices of different functions to save the material cost.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the first embodiment of the invention; and

FIG. 2 is a schematic view of the second embodiment of the invention.

### DETAILED DESCRIPTION OF THE INVENTION

In this specification, we take an oxygen sensor as an embodiment of the invention. The ceramic oxygen sensor contains an upper electrode, a reaction layer, a lower electrode, and a ceramic cavity layer. In this embodiment, the upper and lower electrodes are platinum electrodes. The ceramic substrate of the reaction layer and the ceramic cavity layer are ZrO₂ substrates with ZrO₂—Y₂O₃ being the detecting material.

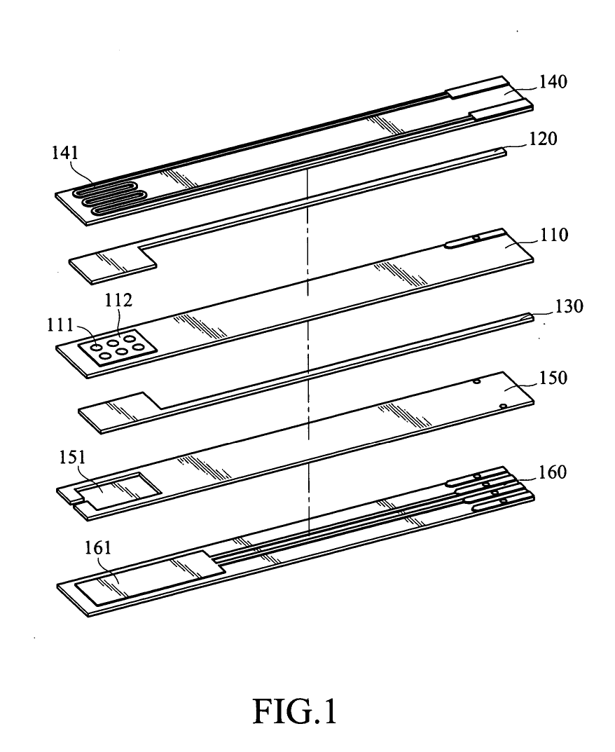

As shown in FIG. 1, the reaction layer 110 is a ceramic substrate with a reaction region on one end. The ceramic substrate has an upper surface and a lower surface. The reaction region contains several duct holes 111 penetrating through the upper and lower surfaces of the ceramic substrate and a reaction film 112 covering the upper surface of the ceramic substrate. The reaction film is made of a detecting material and connected to the duct holes 111. The duct holes are also filled with the detecting material for the reaction film 112. The upper electrode 120 is attached on the reaction film 112. The lower electrode 130 is attached on the lower surface of the reaction layer 110 and connected to the duct holes 111. The ceramic cavity layer 150 is provided on the lower surface of the reaction layer 110 with the lower electrode 130 in between. The ceramic cavity layer 150 has a cavity 151 connecting with the environment and adjacent to the lower electrode 130.

Normally, the oxygen sensor can function normally only under high temperatures. Therefore, one can include a heating device and a temperature detecting device in the oxygen sensor. As shown in FIG. 1, the heating device 140 is a ceramic substrate with a heating electrode 141 coated on its surface. The heating electrode 141 is in touch with the upper electrode 120. The temperature detecting device 160 is a ceramic substrate with a temperature detecting electrode 161 coated on its surface. The temperature detecting electrode 161 is in touch with the ceramic cavity layer 50.

Since the invention is formed using a multilayer ceramic structure, it can be accomplished by the layer-stacking ceramic manufacturing technology. For example, ceramic substrates of different thickness can be made by scraping. The duct holes in the reaction layer and the cavity in the ceramic cavity layer can be formed by wafer hole machining. The detecting material is filled into the duct holes and coated on the electrode using high precision half-tone printing. Finally, all the ceramic layers are stacked together for sintering.

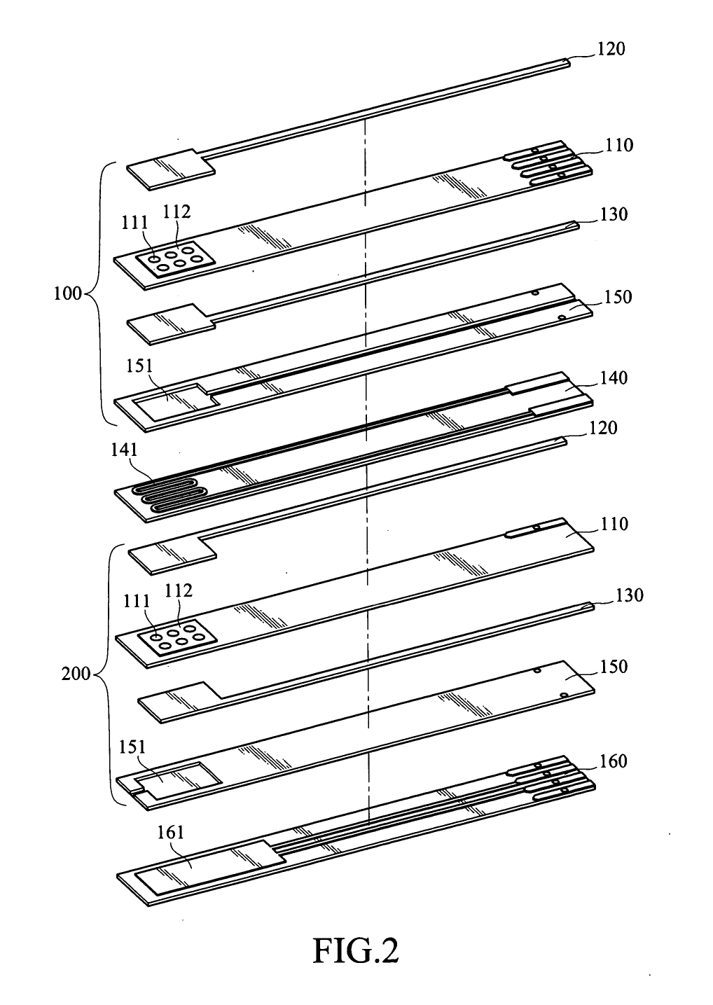

The detecting ability of the invention can be improved by combining several gas sensors. As shown in FIG. 2, a combinatory concentration oxygen detecting device 100 and a threshold current oxygen detecting device 200 form a multilayer ceramic oxygen sensor. The combinatory concentration oxygen detecting device 100 provides a voltage in order to feed back the electric power needed by the system. The threshold current oxygen detecting device 200 obtains an induced current from an imposed voltage.

As shown in FIG. 2, the combinatory concentration oxygen detecting device 100 has an upper electrode 120, a reaction layer 110, a lower electrode 130, and a ceramic cavity layer 150. The reaction layer 110 is a ceramic substrate with a reaction region provided on one end. The ceramic substrate has an upper surface and a lower surface. The reaction region contains several duct holes 111 penetrating through the upper and lower surfaces of the ceramic substrate and a reaction film 112 covering the upper surface of the ceramic substrate. The reaction film 112 is made of a detecting material and connected to the duct holes 111. The duct holes are also filled with the detecting material for the reaction film 112. The upper electrode 120 is attached on the reaction film 112. The lower electrode 130 is attached on the lower surface of the reaction layer 110 and connected to the duct holes 111. The ceramic cavity layer 150 is provided on the lower surface of the reaction layer 110 with the lower electrode 130 in between. The ceramic cavity layer 150 has a cavity 151 connecting with the environment and adjacent to the lower electrode 130. The combinatory concentration oxygen detecting device 100 and the threshold current oxygen detecting device 200 are divided by a heating device 140. The heating device 140 is a ceramic substrate whose surface is coated with a heating electrode 141. The heating device 140 is installed below the ceramic cavity layer 150 of the combinatory concentration oxygen detecting device 100 and above the upper electrode 120 of the threshold current oxygen detecting device 200. The threshold current oxygen detecting device 200 has a similar structure with stacked upper electrode 120, reaction layer 110, lower electrode 130, and ceramic cavity layer 150. The upper electrode 120 and the lower electrode 130 sandwich the reaction layer 110. The reaction layer 110 is a ceramic substrate with a reaction region provided on one end. Its reaction region contains several duct holes 111 penetrating through the upper and lower surfaces of the ceramic substrate and a reaction film 112 covering the upper surface of the ceramic substrate. The ceramic cavity layer 150 is then installed with the lower electrode 130 inserted in between. The ceramic cavity layer 150 has a cavity 151 connecting to the environment. A temperature detecting device 160 is provided at the bottom of the threshold current oxygen detecting device 200. The temperature detecting device 160 is a ceramic substrate whose surface is coated with a temperature detecting electrode 161. The temperature detecting electrode 161 is in touch with the ceramic cavity layer 50 of the threshold current oxygen detecting device 200.

According to the same principles, the disclosed structure can be used to detect nitrogen, oxygen, or hydrogen. The upper and lower electrodes in the ceramic gas sensor can be selected from the group consisting of platinum, gold, silver, and their alloys. The heating electrode can be made of platinum, tungsten, molybdenum, and their metal oxides. According to different detecting requirements, the detecting material can be selected from ZrO₂—CaO, ZrO₂—Y₂O₃, ZrO₂—Yb₂O₃, ZrO₂—Sc₂O₃, and ZrO₂—Sm₂O₃. The ceramic substrate of the reaction layer can be selected from the ZrO₂ substrate, aluminum oxide substrate, ZrO₂/aluminum oxide substrate, and ZrO₂/magnesium oxide substrate.

Certain variations would be apparent to those skilled in the art, which variations are considered within the spirit and scope of the claimed invention.

1. A ceramic gas sensor, comprising:
a reaction layer, which is a substrate with a reaction region provided on one end and has an upper surface and a lower surface, the reaction region containing a reaction film made of a detecting material and a plurality of duct holes, the reaction film covers the upper surface of the substrate and connects to the duct holes, the duct holes penetrate through the upper surface and the lower surface of the substrate, and the duct holes are filled with the detecting material for forming the reaction film;
an upper electrode, which is attached on the reaction film;
a lower electrode, which is attached on the lower surface of the substrate and connected to the duct holes; and
a ceramic cavity layer, which is installed on the lower surface of the reaction layer with the lower electrode inserted in between and has a cavity connecting to the environment, the cavity being adjacent to the lower electrode.

2. The ceramic gas sensor of claim 1, wherein the detecting material is selected from the group consisting of ZrO₂—CaO, ZrO₂—Y₂O₃, ZrO₂—Yb₂O₃, ZrO₂—Sc₂O₃, and ZrO₂—Sm₂O₃.

3. The ceramic gas sensor of claim 1, wherein the substrate is selected from the group consisting of a ZrO₂ substrate, an aluminum oxide substrate, a ZrO₂/aluminum oxide substrate, and a ZrO₂/magnesium oxide substrate.

4. The ceramic gas sensor of claim 1, wherein the upper electrode is made of a material selected from the group consisting of platinum, gold, solver, and their alloys.

5. The ceramic gas sensor of claim 1, wherein the lower electrode is made of a material selected from the group consisting of platinum, gold, solver, and their alloys.

6. The ceramic gas sensor of claim 1 further comprising a heating device attached on the upper electrode.

7. The ceramic gas sensor of claim 6, wherein the heating device is a substrate with a heating electrode.

8. The ceramic gas sensor of claim 7, wherein the heating electrode is made of a material selected from the group consisting of platinum, gold, solver, and their alloys.

9. The ceramic gas sensor of claim 1 further comprising a temperature detecting device attached to the ceramic cavity layer.

10. The ceramic gas sensor of claim 9, wherein the temperature detecting device is a substrate containing a temperature detecting electrode.

11. A ceramic gas sensor, comprising:
a plurality of ceramic gas detecting devices, which includes:
a reaction layer, which is a substrate with a reaction region provided on one end and has an upper surface and a lower surface, the reaction region containing a reaction film made of a detecting material and a plurality of duct holes; wherein the reaction film covers the upper surface of the substrate and connects to the duct holes, the duct holes penetrate through the upper surface and the lower surface of the substrate, and the duct holes are filled with the detecting material for forming the reaction film;
an upper electrode, which is attached on the reaction film;
a lower electrode, which is attached on the lower surface of the substrate and connected to the duct holes; and
a ceramic cavity layer, which is installed on the lower surface of the reaction layer with the lower electrode inserted in between and has a cavity connecting to the environment, the cavity being adjacent to the lower electrode;
a plurality of heating devices, which are provided among the gas detecting devices; and
a temperature detecting device, which is installed at the bottom of the ceramic gas detecting device.

12. The ceramic gas sensor of claim 11, wherein the detecting material is selected from the group consisting of ZrO₂—CaO, ZrO₂—Y₂O₃, ZrO₂—Yb₂O₃, ZrO₂—Sc₂O₃, and ZrO₂—Sm₂O₃.

13. The ceramic gas sensor of claim 1, wherein the substrate is selected from the group consisting of a ZrO₂ substrate, an aluminum oxide substrate, a ZrO₂/aluminum oxide substrate, and a ZrO₂/magnesium oxide substrate.

14. The ceramic gas sensor of claim 11, wherein the upper electrode is made of a material selected from the group consisting of platinum, gold, solver, and their alloys.

15. The ceramic gas sensor of claim 11, wherein the lower electrode is made of a material selected from the group consisting of platinum, gold, solver, and their alloys.

16. The ceramic gas sensor of claim 11, wherein the ceramic gas detecting devices include concentration oxygen sensors and threshold current oxygen detecting devices.

17. The ceramic gas sensor of claim 11, wherein the heating device is a substrate with a heating electrode.

18. The ceramic gas sensor of claim 17, wherein the heating electrode is made of a material selected from the group consisting of platinum, gold, solver, and their alloys.

19. The ceramic gas sensor of claim 11, wherein the temperature detecting device is a substrate containing a temperature detecting electrode.
